(19) United States
(12) Patent Application Publication
(10) Pub. No.: US 2024/0014549 A1
(43) Pub. Date: Jan. 11, 2024

(54) METHOD AND APPARATUS FOR PROCESSING RADIO SIGNALS

(71) Applicant: Focal Point Positioning Limited, Cambridge (GB)

(72) Inventors: Robert Mark CROCKETT, Cambridge (GB); Peter James DUFFETT-SMITH, Cambridge (GB); Ramsey Michael FARAGHER, Cambridge (GB)

(21) Appl. No.: 18/218,877

(22) Filed: Jul. 6, 2023

(30) Foreign Application Priority Data
Jul. 7, 2022 (GB) 2210007.7

(51) Int. Cl. H01Q 3/02; H01Q 1/22

(52) U.S. Cl. CPC H01Q 3/02; H01Q 1/2291

(57) ABSTRACT

A system is disclosed and comprises a mobile platform, an antenna configured to receive a signal from a remote source in a first direction, a movement mechanism mounted to the platform, wherein the antenna is mounted to the movement mechanism, the movement mechanism being configured to move the antenna relative to the platform, and a controller configured to: generate a local signal, determine a component of motion of the antenna in the first direction, correlate the local signal with the received signal to provide a correlation signal, and motion compensating at least one of the local signal, the signal from the remote source, and the correlation signal based on the determined motion of the antenna in the first direction.

### CROSS-REFERENCE

This application claims priority to United Kingdom Application No. 2210007.7, filed Jul. 7, 2022, the entire content of which is incorporated herein by reference.

### FIELD OF INVENTION

Embodiments of the present disclosure relate to a positioning or communication system. More specifically, embodiments of the present disclosure relate to a positioning or communication system that can improve signal reception using motion compensation.

### BACKGROUND TO THE INVENTION

Some positioning systems make use of motion between a positioning device and a reference source to determine a more accurate position of the positioning device. One such technique, known as the SUPERCORRELATION™ technique, is described in commonly assigned patent publication WO 2017/163042, which is hereby incorporated by reference herein in its entirety, performs correlation using motion compensation with respect to motion of a receiver. Motion-compensated signal correlation is particularly useful indoors, or in outdoor environments where buildings can block and reflect signals from remote reference sources, making signals harder to detect.

It would be desirable to be able to perform motion compensation even while the positioning device is stationary or while there is relatively little motion between the positioning device and a reference source. Additionally, there is a demand to be able to perform motion compensation for positioning signals received from a wider range of angles for a given positioning device at one time. Motion compensation can also be used to process radio signals other than positioning signals. Similarly, it would also be advantageous to be able to perform motion compensation for processing radio signals when there is relatively little motion between a source and a receiver.

Embodiments of the present invention advantageously address these demands.

### SUMMARY OF INVENTION

Embodiments of the present invention generally relate to a positioning or communication system that can improve signal reception using motion compensation.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the invention are now described, by way of example, with reference to the drawings, in which:

FIG. 1 is a schematic diagram of a positioning system according to an embodiment of the invention;

FIG. 2 is a schematic diagram of a control system of a positioning device in a positioning system according to an embodiment of the invention;

FIG. 3 is a schematic diagram of part of a positioning system according to an embodiment of the invention;

FIG. 4 is a schematic diagram of part of a positioning system according to an embodiment of the invention;

FIG. 5A is a schematic flow diagram for a method of performing a positioning calculation according to an embodiment of the invention; and

FIG. 5B is a continuation of the method of FIG. 5A of performing a positioning calculation according to an embodiment of the invention.

### DETAILED DESCRIPTION OF THE DRAWINGS

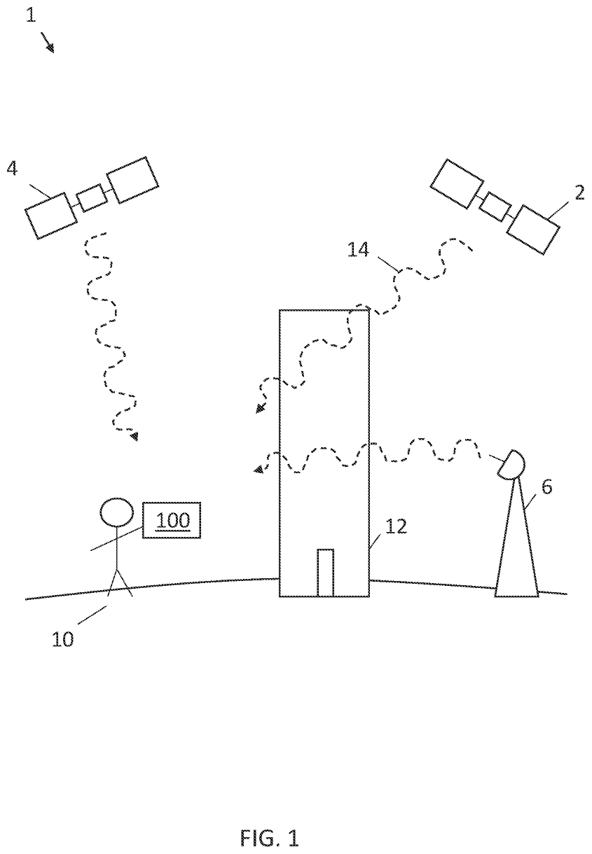

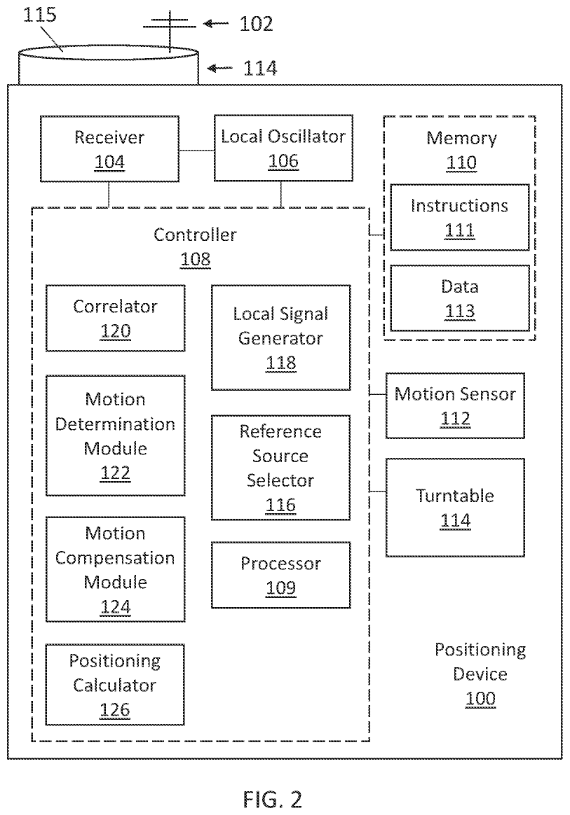

FIG. 1 is a schematic diagram illustrating, by way of example, an environment in which the method and positioning system of the present invention may be used to provide a positioning solution. FIG. 2 is a schematic diagram of a positioning device 100 and its control system.

With reference to FIGS. 1 and 2, a positioning system 1 includes a positioning device 100 comprising an antenna 102 configured to receive signals from remote reference sources. In this example, the positioning device 100 of a user 10 receives radio signals via the antenna 102 from remote reference sources comprising a first satellite 2, a second satellite 4, and a remote ground source 6. A tall building 12 bisects the lines of sight from the positioning device 100 to the second satellite 2 and the ground source 6. The building 12 attenuates the signals from the first satellite 2 and the ground source 6, making the signals weaker and thus making it more difficult for the positioning device 100 to obtain an accurate measurement of position. The same building 12 could also provide a path for a reflected signal from the second satellite 4 to the antenna 102.

As shown in FIG. 2, the example positioning device 100 comprises an antenna 102, a receiver 104 in connection with the antenna 102, a local oscillator 106, a controller 108, a memory 110, a motion sensor 112 and a turntable 114.

The receiver 104 is configured to process signals received by the antenna 102. The receiver 104 may comprise any suitable electronic components, such as an amplifier or an analogue-to-digital converter.

The local oscillator 106 is configured to provide a timing signal for various applications in the positioning device 100, including generating a local signal. The local oscillator 106 may be simple and low cost, and may comprise a quartz oscillator in one example.

The controller 108 is configured to control the operation of the electronic components of the positioning device 100, including the components shown in FIG. 2 as well as other components of the positioning device 100. In this example, the controller 108 comprises a single processor 109 that operates a plurality of modules described further below, the modules configured to perform specific functions. In other embodiments, the modules may be provided separately with different associated processors, or may be provided in a distributed fashion across a network.

The memory 110 may comprise non-transitory computer readable media such as a combination of random access and read-only memory units configured to store executable instructions 111 of the various modules of the controller 108. The memory 110 can also store data 113 used to implement the various modules and instructions 111. The instructions 111 can be executed on the processor 109 to perform the method 500, described further below, as well as other operations of the positioning system 1 described herein.

The motion sensor 112 is configured to determine a motion, for example a speed and acceleration in a particular direction, of the antenna 102. The motion sensor 112 may comprise a plurality of separate motion and/or orientation sensors, such as inertial sensors, gyroscopic sensors, or magnetometers.

The turntable 114 comprises a circular base 115 and a motor (not shown) configured to drive the base 115 to rotate continuously when instructed by the controller 108. The antenna 102 is mounted onto the base 115 so that the antenna 102 follows a substantially circular path when the base 115 is rotated by the motor. In other example embodiments, the turntable 114 may comprise other suitable components, such as a non-circular base or other means of driving the base.

In this example, the motion sensor 112 is co-located with the antenna 102 in the base 115. Thus, the motion sensor 112 can detect motion of the antenna 102 arising from rotation of the turntable 114 as well as motion of the platform 113.

Alternatively, the motion sensor 112 could be located elsewhere to determine a motion of the positioning device 100. In this case, a separate aspect of the motion of the antenna 102, caused by the turntable 114, could be determined according to a formula of predictable motion generated by the turntable 114. Alternatively, the motion of the antenna 102 could be determined by an additional motion or rotation sensor, such as a tachometer. In this case, the composite motion of the antenna 102 may be calculated based on measurements from the motion sensor 112, implemented to determine the motion of the positioning device 100, and the additional motion sensor.

In this example, the positioning device 100 is a smartphone and the antenna 102 and the turntable 114 are housed inside the smartphone. However, for the purposes of illustration the turntable 114 and the antenna 102 are shown as external to the positioning device 100 in FIG. 2. In other examples, the positioning device 100 may be configured as a laptop, vehicle, or any other type of portable device.

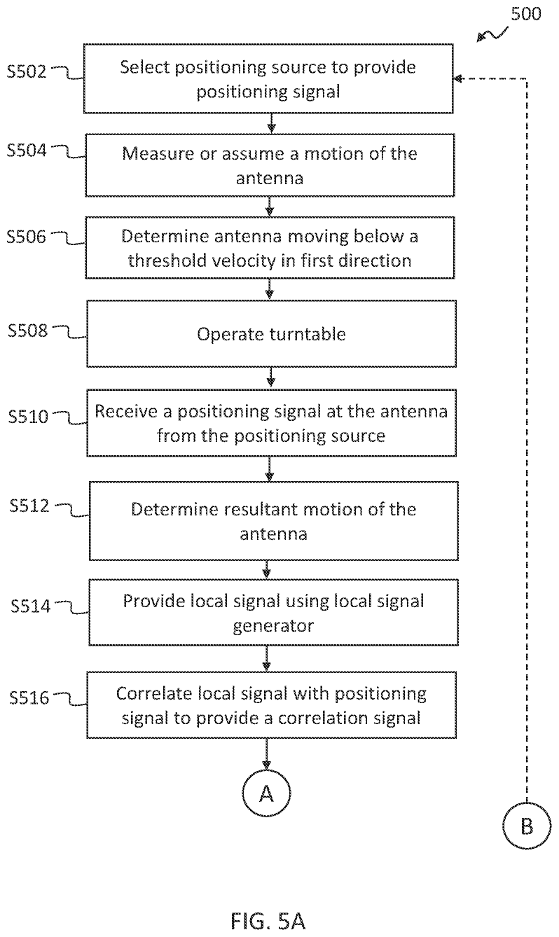

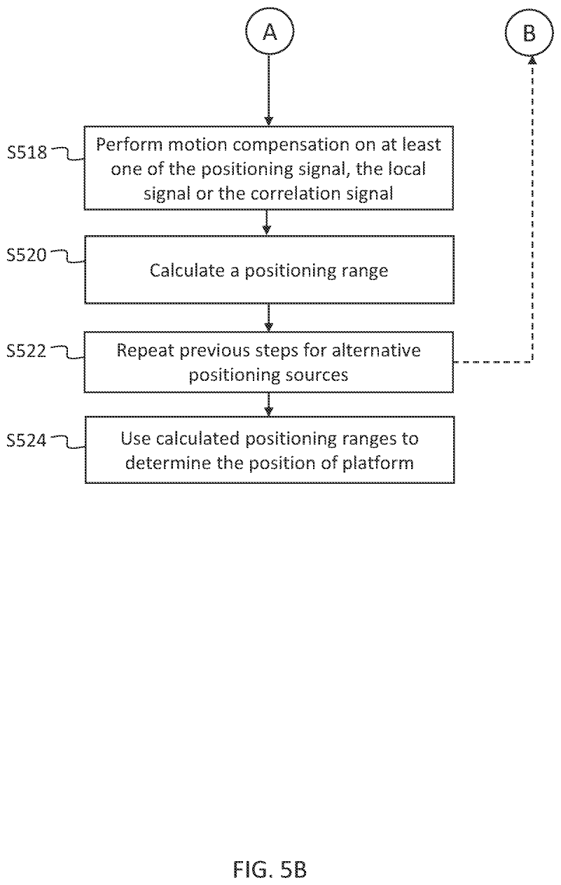

The controller 108 comprises a number of modules, including a reference source selector 116, a local signal generator 118, a correlator 120, a motion determination module 122, a motion compensation module 124 and a positioning calculator 126. The functionality of these modules of the controller 108 are described further below with reference to FIGS. 5A and 5B. These modules may be hardware, software, or a combination thereof. In one embodiment, one or more of the modules may be implemented by execution of software instructions 111 stored in memory 110 by the processor 109 of the controller 108.

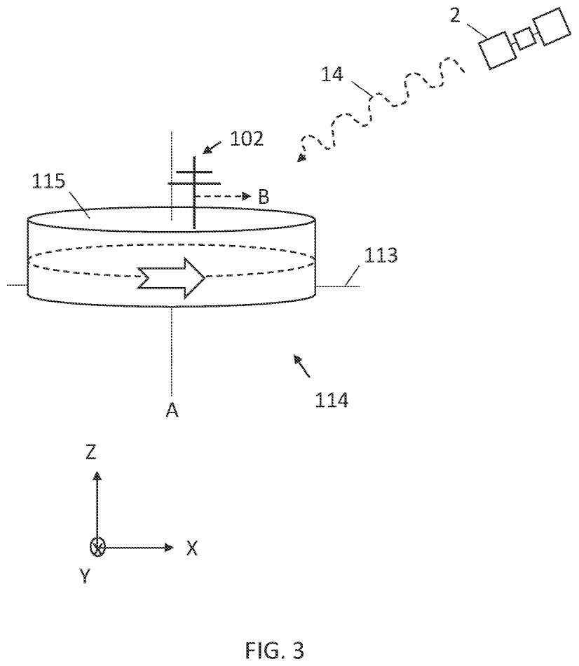

FIG. 3 shows a schematic diagram of a portion of the positioning system 1 in an example usage scenario. An axis is shown in the bottom left corner of FIG. 3, wherein the Y-axis extends into the page.

The positioning device 100 further comprises a platform 113 that is fixed to the positioning device 100. The turntable 114 is mounted to the platform 113, as shown in FIG. 3, so that the base 115 can rotate relative to the platform 113 when driven by the motor. In this example, the turntable 114 and platform 113 are incorporated within a housing (not shown) of the positioning device 100.

In the example of FIG. 3, the positioning device 100 is stationary relative to the Earth, which could occur when the user 10 is holding the positioning device 100 and standing still. The first satellite 2 is oriented and moving relative to the positioning device such that there is no or an insignificant amount of relative motion between the platform 113 and the first remote source 2 along their shared line of sight.

As shown in FIG. 1, a building 12 obstructs a positioning signal 14 received along the line of sight from the first satellite 2, thereby attenuating the positioning signal 14 and making it harder to detect compared to reflected signals from the first satellite 2. Ordinarily, using known positioning systems, it would be desirable, but not possible due to a lack of line of sight motion, to perform motion compensation. Performing motion compensation increases the gain of line of sight signals compared to non-line-of-sight signals. This can allow very weak line of sight signals to be detected. In other scenarios, it allows the receiver 104 to lock on to a line of sight signal rather than a reflected signal, which produces a less accurate pseudorange. However, known positioning systems would require motion of the positioning device 100, or equivalently of the platform 113 onto which the antenna 102 is mounted, along the line of sight direction to the first satellite 2 in order to perform motion compensation.

To remedy this issue, the controller 108 is configured to instruct the turntable 114 to rotate in order to generate motion of the antenna 102 along the line of sight to the first satellite 2, as shown by the arrow B in FIG. 3. This allows motion compensation to be performed by the controller 108 despite the fact that there is not enough relative motion between the platform 113 and the first satellite 2 in the line of sight direction to perform motion compensation.

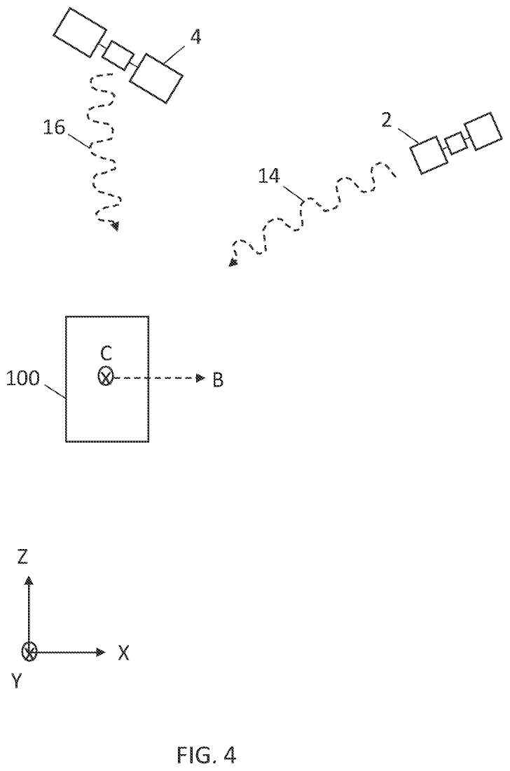

FIG. 4 shows a schematic diagram of a portion of the positioning system 1 in an alternative example usage scenario. An axis is shown in the bottom left corner of FIG. 4, wherein the Y-axis extends into the page.

In this example usage, the positioning device 100, and hence the platform 113 and antenna 102, are moving in the positive Y direction, as shown by arrow C. The second satellite 4 is positioned distantly in the positive Z and Y directions, while the first satellite 2 is positioned distantly in the positive Z and X directions and moving substantially parallel to the Y-axis, as in the example of FIG. 3.

Ordinarily, using known positioning systems, in this situation it would only be possible to perform motion compensation on a positioning signal 16 received from the second satellite 4 based on motion of the platform 113 along the Y direction. However, the turntable 114 can move the antenna 102 in order to generate motion along the X direction, as shown by arrow B, enabling motion compensation to be performed for the signal 14 received from the first satellite 2. This enables the positioning device 100 to determine a positioning range from both the first satellite 2 and the second satellite 4. In this way, the turntable 114 increases the range of angles from which signals can be received that can be detected more effectively using motion compensation. In other words, the use of motion of the antenna 102 relative to the platform 113 increases the angular sensitivity of the antenna 102.

In more detail, each axis along which the antenna 102 is moving relative to a reference source generates two “cones of sensitivity” (one cone for each direction along the axis, each cone diverging from the antenna 102) on the sky. Each cone is centred on the axis of movement. Motion compensation allows the gain of very weak line of sight signals from remote sources near the axis of the cone to be increased, but motion compensation is less effective at increasing the gain of line of sight signals from remote sources at positions on the sky or horizon that are more offset from the axis of motion. For remote sources perpendicular to the axis of motion, performing motion compensation would not allow the positioning system 1 to increase the gain of weak line of sight positioning signals.

In this example, the motion C of the platform 113 generates first cones of sensitivity along the Y-axis, whereas the rotation B of the turntable 114 can generate second cones of sensitivity along the X-axis.

The second cones of sensitivity generated by the rotation B of the antenna 102 sweep the sky as the base 115 rotates to move the antenna 102 in a circular path. Thus, motion compensation can be performed for positioning signals received from any direction, except for remote sources directly overhead. For this reason, rotational motion is particularly preferred. However, it has also been found that motion compensation is made more effective when based on non-linear motion, which is also provided by rotational motion.

The embodiments described above have been described with respect to positioning devices and positioning signals received from satellite or other positioning sources. However, motion compensation can also be used to process radio signals in other systems, such as in communications channels, more effectively. In this case, it would be similarly advantageous to be able to perform motion compensation between a radio source and a receiver in a wider variety of motion scenarios. It should be understood that the positioning device 100, positioning system 1 and method 500 of the invention described herein can be applied equally to other types of systems utilising radio signals.

FIGS. 5A and 5B show an example method 500 according to the invention for determining a position of the positioning device 100 using the positioning system 1.

In step 502, the reference source selector 116 selects a particular reference source from which to receive a positioning signal. The reference source selector 116 may select any suitable available reference source. In this example, the reference source selector 116 selects the first satellite 2, which emits a positioning signal 14 along the line of sight to the antenna 102. The positioning signal 14 is received at the antenna 102 with a poor signal strength due to attenuation by the tall building 12 that intersects the line of sight from the first satellite 2 to the antenna 102. Therefore, the positioning signal 14 must be processed using motion compensation in order to improve the sensitivity of detection.

Steps S504 to S508 can be optionally performed in order to determine when to operate the turntable 114, when the turntable 114 is operated selectively rather than continuously. Thus, in steps S504 to S508 the turntable 114 is stationary and hence the antenna 102 is stationary relative to the platform 113.

In step S504, the motion determination module 122 determines a motion of the antenna 102. The motion determination module 122 may utilise data provided by the motion sensor 112, which may include a plurality of measurements from different constituent motion and/or orientation sensors, to determine a motion of the antenna 102. Specifically, the motion determination module 122 determines the motion along the line of sight to the currently selected positioning source, in this case the first satellite 2. An approximate position of the first satellite 2 and an approximate position of the positioning device 100 can be used to determine the line of sight direction. In turn, this can be used to calculate the relative motion between the antenna 102 and the first satellite 2. The approximate position and direction of motion of the first satellite 2 may be stored locally in the data 113 of the memory 110 in a lookup table or may be retrievable from satellite ephemeris or an online source, as is well understood in the art.

The motion of the antenna 102 can be measured directly using the motion sensor 112, as just described. Alternatively, the motion could be assumed or inferred based on previous measurements from the motion sensor 112 or recent positioning calculations. For example, if it has been calculated or measured that the platform 113 is moving at a fixed speed in a straight direction, e.g. while driving or on a train, it may be possible to assume the motion of the antenna 102 based on a calculation. This may be simpler or less computationally intensive in some cases than performing a measurement.

At step S506, the motion determination module 122 optionally determines that the platform 113 is moving below a threshold velocity in the line of sight direction to the first satellite 2. Thus, the controller 108 infers that motion compensation cannot be performed using motion of the platform 113 alone. Alternatively, the motion determination module 122 may determine that the platform 113 is moving below a threshold speed in any direction, which may be simpler and less computationally intensive.

At step S508, in response, the controller 108 instructs the turntable 114 to move, thereby generating non-linear motion of the antenna 102 relative to the platform 113. This generates sufficient line of sight movement between the antenna 102 and the first satellite 2 to perform motion compensation even while the platform is static.

Alternatively, the turntable 114 may be configured to rotate continuously while the positioning device 100 is operating, in which case steps S504, S506 and S508 would not be required.

The turntable 114 may be configured to rotate at a particular rate of rotation. In some examples, the controller 108 may instruct the turntable to vary the rate of rotation depending on the relative orientations of the platform 113 and the first satellite 2 in order to maximise the effectiveness of the motion compensation. Equally, other means of providing rotational motion of the antenna 102 may be configured to rotate or vary a speed of rotation in the same way.

At step S510, the antenna 102 receives the positioning signal 14 from the first satellite 2.

At step S512, the motion determination module 122 determines a motion of the antenna 102. The motion sensor 112 is co-located with the antenna 102 and hence detects the resultant motion of the antenna 102 due to motion of the platform 113 and the turntable 114. In one alternative embodiment, the motion sensor 112 may be located elsewhere to measure the motion of the platform 113 and one or more additional sensors may be provided to measure the speed and position of the antenna 102 relative to the platform 113. In another example, the motion generated by the turntable 114 may be characterised in one or more formulas stored in the memory 110, which can be used to infer a speed and direction of the antenna 102 at the time during which the positioning signal 14 is received.

In any case, the motion determination module 122 performs a calculation to determine a motion of the antenna 102 along the line of sight direction. This line of sight motion is used in a subsequent step to perform motion compensation. If the platform 113 is determined to be stationary at step S506, the motion of the antenna 102 is comprised only of circular motion caused by the turntable 114.

At step S514, the local signal generator 118 generates a local signal. In this example, the local signal is a pseudorandom number sequence that replicates the positioning signal 14. In general, a received positioning signal may include any known or unknown pattern of transmitted information, either digital or analogue. The presence of such a pattern can be determined by a cross-correlation process using a local copy of the same pattern (in this example, the local signal). Received positioning signals may be encoded with a chipping code that can be used for ranging. Examples of such received signals include GPS signals, which include Gold Codes encoded within the radio transmission. Another example is the Extended Training Sequences used in GSM cellular transmissions.

At step S516, the correlator 120 is configured to correlate the local signal with the positioning signal 14 received from the first satellite 2 to provide a correlation signal.

At step S518, the motion compensation module 124 performs motion compensation on at least one of the local signal, the received positioning signal 14 or the correlation signal. This involves adjusting the relevant signal chosen for motion compensation to account for changes in the received positioning signal 14 that arise due to the relative motion along the line of sight between the antenna 102 and the first satellite 2. These techniques are described in WO 2017/163042, however any other suitable motion compensation technique can also be used. Step S518 may occur before step S516 when motion compensation is applied to the positioning signal 14 or the local signal.

By providing motion compensation in the direction that extends between the antenna 102 and the first satellite 2, it is possible to achieve preferential gain for signals received along this direction. Thus, a line-of-sight signal between the antenna 102 and the first satellite 2 will receive gain preferentially over a reflected signal, e.g. from a nearby building, that is received in a different direction. In a GNSS receiver, this can lead to a remarkable increase in positioning accuracy and a better estimate of the signal phase because non-line-of-sight signals (e.g. reflected signals) are significantly suppressed. Applying motion compensation ensures the highest correlation may be achieved for the line-of-sight signal, even if the absolute power of this signal is less than that of a non-line-of-sight signal. However, even in cases where there are no reflected signals, applying motion compensation boosts the signal to noise ratio of the received positioning signals to enable extremely weak line of sight signals to be detected.

The motion compensation can be performed by generating and combining phasor sequences with at least one of the local signal, the received positioning signal 14 or the correlation signal. In this case, the motion compensation module 124 receives the determined movement of the antenna 102 from the motion determination module 122 and generates a phasor sequence in accordance with the antenna's motion in the line of sight (straight line) direction between the antenna 102 and the first satellite 2.

Each phasor sequence ϕ comprises a plurality of phasors, with each phasor typically having the same time duration as a sample of the received signal. There is typically the same number, N, of phasors ϕ(I=1. . N) in a generated phasor sequence ϕ as there are samples of the received signal and samples of the local signal during the time period within which the signal received and the antenna movement is measured. Each phasor ϕi represents a phase and/or amplitude compensation based upon the motion of the antenna 102 at a time t such that a phasor sequence made up of a plurality of phasors is indicative of the antenna motion along a particular direction as a function of time. For example, a measured or assumed velocity of the antenna 102 from the motion determination module 122 may be used to determine a Doppler frequency shift due to the motion of the antenna 102 along the line-of-sight direction to the first satellite 2. The Doppler frequency shift may then be integrated over time in order to estimate a phase value.

Thus, the phasor sequence may also be referred to as a “motion-compensated” phasor sequence.

A phasor ϕi is a transformation in phase space and is complex valued, representing the in-phase components of the motion-compensated phasor sequence via its real component, and the quadrature phase components of the motion-compensated phasor sequence via its imaginary component. The phasor ϕi is typically a cyclic phasor and may be expressed in a number of different ways, for example as a clockwise rotation from the real axis or as an anti-clockwise rotation from the imaginary axis. As explained above, the phasor sequence for each direction is indicative of the measured or assumed movement of the antenna 102 along that direction. Once the phasor sequence has been generated, the phasor sequence can be combined with any of the local signal, the received positioning signal 14 or the correlation signal to perform motion compensation at step S518. It would be apparent to the skilled person how to generate and combine the generated phasor sequence with the local signal, received positioning signal 14, or the correlation signal in each case. Further details are also provided in WO 2017/163042.

In step S520, the positioning calculator 126 calculates a positioning range or pseudorange associated with the first satellite 2 based on the result of the motion compensated correlation. As known in the art, the precise position of the positioning device 100 can be inferred by obtaining positioning ranges from at least three further reference sources and determining the intersection between the four calculated ranges.

In step S522, the controller 108 returns to previous step S502, in order to perform steps S502 to S520 for additional sources from which a positioning signal is being received by the antenna 102, although in practice these steps would generally be undertaken in parallel. For example, these steps may be repeated for the second satellite 4, the ground source 6, and a further remote reference source.

At step S524, the positioning calculator 126 uses the at least four determined ranges to calculate a position of the positioning device 100.

The positioning device can comprise further antennas on the turntable 114 (or other movement mechanism) in addition to the antenna 102, each of which may be configured to receive different types of positioning signals, such as L1 and L5 signals. In this case, the method 500 may be performed individually for each antenna on the turntable 114, in parallel or sequentially.

Further applications, uses and details of motion compensation may be found in commonly assigned patent publications WO 2017/163042, WO2019/063983 and WO2019/058119, which are hereby incorporated herein by reference in their entirety.

According to an aspect of the invention there is provided an apparatus configured to process radio signals, comprising: a mobile platform; an antenna configured to receive a signal from a remote source in a first direction; a movement mechanism mounted on the platform, wherein the antenna is mounted on the movement mechanism, the movement mechanism being configured to move the antenna relative to the platform; and a controller configured to: generate a local signal; determine a component of motion of the antenna, along the first direction; provide a correlation signal by correlating the local signal with the received signal; and motion compensating at least one of the local signal, the received signal, and the correlation signal based on the determined motion of the antenna in the first direction.

Performing motion compensation requires at least some relative motion between the remote source and the antenna along the first direction. This direction may be the straight-line direction between the remote source and the antenna whether blocked by intervening objects or not, or it may be another direction of interest. The movement mechanism of embodiments of the present invention provides movement of the antenna in the first direction. This allows the apparatus to perform motion compensation even while there is little or no relative movement between the platform and the remote source in the first direction. In one example scenario, the platform may be stationary. In another scenario, the platform may be moving in a substantially perpendicular direction to the first direction. In both cases, the motion of the antenna in the first direction provided by the movement mechanism allows motion compensation to be performed despite the lack of movement in the first direction of the platform. In this way, motion compensation can be used in a wider variety of situations.

The apparatus can be a positioning system, and the signal can be a positioning signal from a remote positioning source, such as a GNSS satellite or a terrestrial source. In other embodiments, the apparatus may be designed as a transceiver of communications signals such as WiFi signals, Bluetooth signals, cellular signals, and the like.

The mobile platform can also be described as a platform mounted to a body comprising any type of locomotion equipment, such as wheels for ground travel or propellors for flight. The mobile platform can be provided in or on any mobile device. The mobile device can be configured to be carried or to move locations when performing motion compensation. For instance, the mobile device may comprise one or more sensors that enables a composite motion of the antenna to be determined.

In some specific examples, the platform can be provided in a mobile computing device such as a smartphone or tablet, or a vehicle, any of which may also be configured as a positioning device. Motion of the platform itself, caused by, e.g., motion of the device on which the platform is provided, can also be used to perform motion compensation where the first direction and the movement of the platform are not perpendicular. In this scenario, motion compensation is performed based on the composite or resultant motion of the antenna in the first direction caused by both the motion of the platform and the movement mechanism. Thus, the platform can be moving or stationary, and the motion of the antenna can be caused by both the platform motion and the movement mechanism.

The movement mechanism can be configured to move the antenna linearly or non-linearly relative to the platform. For an antenna moving along a fixed straight path, there are ambiguities in the Doppler measurements arriving from off-axis directions. The only way to resolve these ambiguities is to ensure the path is not a straight line. Non-linear motion in 2D, and ideally in 3D, ensures that different directions around the platform can be uniquely resolved by their Doppler profiles. Maintaining motion of the antenna even when the platform is static is also advantageous. For this reason, non-linear motion generated by the movement mechanism may provide better results. Nevertheless, using the movement mechanism to generate linear motion of the antenna can still enable motion compensation to be performed in a wider variety of situations.

There may be more than one antenna on the platform or movement mechanism. The apparatus may comprise a first antenna mounted on the movement mechanism configured to receive a first type of signal and a second antenna mounted on the movement mechanism configured to receive a second type of signal. For example, a GNSS receiver may use separate antennas for the L1 and L5 frequencies. Alternatively, more than one antenna may be allocated to each frequency in use.

The platform may comprise a base or any other suitable structure on which the movement mechanism can be mounted. In one example, the platform may be an internal base or housing of a device or positioning device on which various electronic components of the positioning device are mounted.

In one example, the remote source is a GNSS (Global Navigation Satellite Systems) satellite and the positioning system is a GNSS system. The remote source, which may be referred to alternatively as a positioning or reference source, may operate as part of any navigation system known in the art. In general, the positioning system can comprise any combination of satellite sources, terrestrial sources, or other types of reference sources.

The local signal may be a replica of a received signal, or pseudorandom number sequence from a GNSS satellite, or similarly well-known content within a communication channel broadcast, such as a synchronisation word.

The motion compensation can be applied using techniques known in the art. For example, the motion compensation can be applied to one or more of: the received signal, the local signal, or a correlation signal resulting from correlating the received signal and the local signal. Similarly, the correlation step may be performed using known correlation techniques in GNSS or other positioning or communication systems.

The step of providing motion compensation may comprise: generating a phasor sequence comprising one or more phasors indicative of the amplitude and/or phase changes introduced into the received signal as a result of the determined movement of the antenna in the first direction, each phasor including an amplitude and/or a phase angle, and combining the phasor sequence with said at least one of the local signal, the received signal, and the correlation signal.

A phasor sequence comprises one or more phasors which are indicative of the amplitude and/or phase changes introduced into the received signal as a result of the determined motion of the antenna. Each phasor comprises at least one of an amplitude and phase angle that describes the determined movement of the antenna in the respective direction. Typically, the phasor sequence is derived from the determined movement of the antenna as a function of time. For example, each phasor within a phasor sequence may be indicative of the determined movement of the antenna during a particular time interval. Thus, the resulting phasor sequence is indicative of (e.g. corresponds to) the determined movement of the antenna during a time period made up of the individual time intervals. The phasor sequence may reflect a detailed movement of the antenna in time. For example, the plurality of phasors within a phasor sequence may reflect the motion of the antenna while it is being moved by the movement mechanism.

In one embodiment, the movement mechanism is configured to move the antenna cyclically relative to the platform, in one, two or three spatial dimensions. In this way, the movement mechanism can continuously move the antenna along a given path. This can enable motion compensation to be performed at any time using the cyclical motion. Additionally, movement mechanisms that are simple to implement generally utilise some form of cyclical motion.

In one embodiment, the movement mechanism is configured to provide a substantially circular motion of the antenna relative to the platform. In this way, the angular sensitivity of the antenna can be improved. Additionally, it has been found that motion compensation is more effective when there is non-linear and non-transverse movement between the antenna and the remote source. Providing continuous and variable non-linear motion therefore improves the effectiveness of the motion compensation. In other embodiments, other types of motion may be provided by the movement mechanism, such as linear, circular, elliptical, reciprocating, random, dithered, or oscillatory motion.

In one embodiment, the movement mechanism comprises a turntable on which the antenna is mounted. A turntable may be a particularly simple implementation of a movement mechanism, thereby reducing the cost of implementing the movement mechanism. The turntable may be driven by an electric motor or by any other means.

The turntable, or any other means of providing non-linear motion, may be configured to move the antenna at a rate, such that the antenna moves through at least ¼ of a wavelength of the incoming radiation during the coherent integration time of the correlation process.

In other embodiments, other movement mechanisms may be provided, such as, but not limited to, sliding, vibrating, oscillating, jiggling, gyrating, quivering or wobbling.

In one embodiment, the apparatus comprises a motion sensor configured to measure a motion of the platform, wherein controller is configured to determine the motion of the platform based on a measurement performed by the motion sensor.

The controller can also be configured to instruct the movement mechanism to move the antenna and to perform motion compensation in response to determining that the platform is moving below a threshold velocity, at least in the first direction. In this way, the positioning system may be more energy efficient by operating the movement mechanism only when required to perform motion compensation in the first direction. In some examples, the controller may determine the component of the motion of the platform in the first direction before instructing the movement mechanism to move the antenna. In other examples, the controller may determine that the platform is moving below a threshold speed in any direction before instructing the movement mechanism to move the antenna. In another example the antenna is permanently undergoing linear or non-linear motion of its own, regardless of the platform motion.

The motion sensor may comprise one or more of any kind of motion sensing component, such as an inertial or gyroscopic sensor configured to determine an acceleration, or a magnetometer configured to determine an orientation. The motion sensor may be co-located with the antenna in order to determine the motion of the antenna. For example, the motion sensor may be co-located with the antenna in the movement mechanism.

In other examples, the motion sensor may be located elsewhere, such as fixed to the platform or in a fixed position relative to the platform. In this case, the resultant motion of the antenna may be determined or calculated by combining the measured motion of the platform with the measured motion of the antenna relative to the platform. In one example, a sensing element may be co-located with the antenna and the motion sensor may track the movement of the sensing element. Alternatively, the motion of the antenna due to the movement mechanism may be calculated based on a measured motion of the platform and a predictable movement of the movement mechanism. Determining a particular component of motion along a direction to a remote source can be performed using any suitable technique known in the art.

In another example, there are motion sensors mounted on the platform and separate motion sensors co-located with the antenna.

The controller may be able to assume that the platform is moving in a certain direction at a certain speed based on a set of previous positioning calculations. For example, when the platform is incorporated into a device that is moving along a long, straight road at a steady speed, the controller may be able to assume or determine a measurement of the platform rather than use a direct measurement from the motion sensor.

In other embodiments, the movement mechanism is configured to move the antenna continuously regardless of whether the controller determines the platform to be in motion or stationary. This may avoid performing additional measurements and computations to determine if it is necessary to operate the movement mechanism, which may be more efficient in some scenarios.

In some embodiments, the platform is provided in or on a vehicle. The platform may be mounted on a wheeled body. In one example, the platform may be provided on the roof of a vehicle, which may avoid attenuation of received positioning signals by the body or roof of the vehicle. The movement mechanism may be positioned relative to a set of wheels of the vehicle to enable the movement mechanism to move the antenna in a plane substantially perpendicular to the set of wheels. In this manner, the motion of the platform can provide antenna movement in one dimension, while the movement mechanism can provide antenna movement in the perpendicular direction, in which the platform itself cannot move. This is particularly advantageous, for example, for platforms moving in urban environments in which signals are reflected from tall buildings either side of the direction of travel. The antenna movement perpendicular to the platform's direction of travel allows the system to distinguish between signals reflected from the buildings on either side of the street.

In some embodiments, the platform is provided in any mobile device or mobile computing device, such as smartphone or a laptop. The platform, antenna and movement mechanism may be provided as an internal component of the mobile device.

In some embodiments, it may be necessary to remove the effects of phase-wind up or wind down caused by the determined rotation of the antenna, as is already known in the art.

The movement mechanism can be configured to move the antenna in one, two or three dimensions. In this case of two or three dimensions, this increases the flexibility of the movement mechanism and allows motion compensation to be performed for signals received from a greater range of angles for a platform of a given orientation. The movement mechanism can be any kind of movement mechanism configured to generate motion of the antenna along one, two or three dimensions or axes.

In an embodiment, the apparatus may comprise a plurality of movement mechanisms and a plurality of antennas mounted respectively to the plurality of movement mechanisms, wherein each of the plurality of movement mechanisms are configured to move a respective antenna of the plurality of antennas relative to the platform. In other words, the apparatus may comprise first and second movement mechanisms on which first and second antennas are mounted, respectively.

Each antenna may receive a respective signal, which can be processed by the controller using motion compensation that is made possible by the movement of each antenna relative to the platform caused by a corresponding movement mechanism. The platform may have two or more movement mechanisms, each carrying one or more antennas. The movement mechanisms may be configured to move independently of each other in orthogonal directions, thus providing 2D motion. Three movement mechanisms moving antennas orthogonally may provide 3D motion that can be used to perform motion compensation in any direction.

In an embodiment, the movement mechanism comprises a further antenna, or, in other words, may comprise a first antenna and a second antenna. The movement mechanism can be configured to move the second antenna relative to the platform to enable the controller to perform motion compensation on signals received at the second antenna. The first and second antennas may be configured to receive different radio frequencies. In this way, the apparatus can improve the detection of several different frequency bands in a compact arrangement. More than two antennas may be provided on a single movement mechanism, each configured to detect different bands of radio signals.

According to an aspect of the invention there is provided a method for processing radio signals, which can be performed in a positioning system, comprising: providing a local signal; providing an antenna movably mounted to a mobile platform; receiving a signal at the antenna from a remote source in a first direction; moving the antenna relative to the platform; determining a motion of the antenna; correlating the local signal with the received signal to provide a correlation signal; and motion compensating at least one of the local signal, the received signal, and the correlation signal based on the determined motion of the antenna in the first direction.

According to an aspect of the invention there is provided a non-transitory computer readable medium storing executable instructions that, when executed by a processor, cause the processor to perform steps comprising: providing a local signal; moving an antenna movably mounted to a mobile platform relative to the platform, wherein the antenna receives a signal from a remote source in a first direction; determining a motion of the antenna; correlating the local signal with the received signal to provide a correlation signal; and motion compensating at least one of the local signal, the received signal, and the correlation signal based on the determined motion of the antenna in the first direction.

Here, multiple examples have been given to illustrate various features and are not intended to be so limiting. Any one or more of the features may not be limited to the particular examples presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the invention presented herein. The invention is not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g. A, AB, AC, ABC, ABB, etc.). When “and/or” is used, it should be understood that the elements may be joined in the alternative or conjunctive.

While the foregoing is directed to embodiments of the present invention, other and further embodiments of the invention may be devised without departing from the basic scope thereof, and the scope thereof is determined by the claims that follow.

1. An apparatus configured to process radio signals, comprising:
a mobile platform;
an antenna configured to receive a signal from a remote source in a first direction;
a movement mechanism mounted on the platform, wherein the antenna is mounted on the movement mechanism, the movement mechanism being configured to move the antenna relative to the platform; and
a controller configured to:
generate a local signal;
determine a component of motion of the antenna, along the first direction;
correlate the local signal with the received signal to generate a correlation signal; and
motion compensate at least one of the local signal, the received signal, and the correlation signal based on the determined motion of the antenna in the first direction.

2. The apparatus of claim 1, wherein the movement mechanism is configured to move the antenna cyclically relative to the platform.

3. The apparatus of claim 2, wherein the movement mechanism is configured to provide a substantially circular or elliptical motion of the antenna relative to the platform.

4. The apparatus of claim 3, wherein the movement mechanism comprises a turntable on which the antenna is mounted.

5. The apparatus of claim 1, wherein the movement mechanism is configured to move the antenna in one, two or three dimensions.

6. The apparatus of claim 1, further comprising a motion sensor configured to measure a motion of the platform, wherein the controller is configured to determine the motion of the platform based on a measurement performed by the motion sensor.

7. The apparatus of claim 6, wherein the controller is configured to instruct the movement mechanism to move the antenna and to perform motion compensation in response to determining that the platform is moving below a threshold velocity, at least in the first direction.

8. The apparatus of any of claim 1, wherein the movement mechanism is configured to move the antenna continuously regardless of whether the controller determines the platform to be in motion or stationary.

9. The apparatus of claim 1, wherein the platform is provided in or on a vehicle or human-portable device.

10. The apparatus of claim 1, wherein the platform is provided in or on a body comprising locomotion equipment.

11. The apparatus of claim 1, wherein the platform is provided in a mobile device, such as a smartphone or laptop computer.

12. The apparatus of claim 1, comprising a plurality of movement mechanisms and a plurality of antennas mounted respectively to the plurality of movement mechanisms, wherein each of the plurality of movement mechanisms are configured to move a respective antenna of the plurality of antennas relative to the platform.

13. The apparatus of claim 1, wherein the movement mechanism comprises a further antenna.

14. A method, for processing radio signals, comprising:
providing a local signal;
receiving a signal at the antenna from a remote source in a first direction, wherein the antenna is movably mounted to a mobile platform;
moving the antenna relative to a mobile platform to induce motion between the antenna and the remote source;
determining a component of motion of the antenna in the first direction;
correlating the local signal with the received signal to provide a correlation signal; and
motion compensating at least one of the local signal, the received signal, and the correlation signal based on the determined motion of the antenna in the first direction.

15. The method of claim 14, wherein moving the antenna comprises cyclically moving the antenna relative to the platform.

16. The method of claim 15, wherein cyclically moving the antenna comprises providing substantially circular or elliptical motion of the antenna relative to the platform.

17. The method of any of claim 14, wherein the steps of moving the antenna and providing motion compensation are performed in response to determining that the platform is moving below a threshold velocity, at least in the first direction.

18. The method of any of claim 14, wherein moving the antenna comprises moving the antenna continuously regardless of whether the platform is determined to be in motion or stationary.

19. The method of claim 14, wherein moving the antenna comprises moving the antenna in one, two or three dimensions.

20. A non-transitory computer readable medium storing executable instructions that, when executed by a processor, cause the processor to perform steps comprising:
providing a local signal;
moving an antenna movably mounted to a mobile platform relative to the platform, wherein the antenna is configured to receive a signal from a remote source in a first direction;
determining a component of motion of the antenna in the first direction;
correlating the local signal with the received signal to provide a correlation signal; and
motion compensating at least one of the local signal, the received signal, and the correlation signal based on the determined motion of the antenna in the first direction.
